(19) United States
(12) Patent Application Publication
(10) Pub. No.: US 2014/0359785 A1
(43) Pub. Date: Dec. 4, 2014

(54) Security for Displayed Electronic Content from Unauthorized Access During Application Idle Periods

(71) Applicant: Microsoft Corporation, Redmond, WA (US)

(72) Inventor: Omeed Chandra, Redmond, WA (US)

(73) Assignee: MICROSOFT CORPORATION, Redmond, WA (US)

(21) Appl. No.: 13/906,069

(22) Filed: May 30, 2013

(51) Int. Cl. G06F 21/60

(52) U.S. Cl. CPC G06F 21/60
USPC 726/27

(57) ABSTRACT

Security for displayed information during periods in which the displayed information may be accessed before being locked from view is provided. When a computing device operating system notifies an application that processing for the application will be suspended due to idle operation, the application may automatically overlay the document with a security cover to prevent unauthorized review or screen capture of the document. If the application becomes active prior to the elapse of a predetermined allotted time after the notification, the security cover may be automatically removed. However, if the predetermined allotted time after the notification elapses prior to the application becoming active, the application document may be encrypted, and password entry may be required to gain subsequent access to the document.

### BACKGROUND

With the almost universal use of electronic devices for preparing, editing and displaying data of all types, any given computing device display screen that is presently in use may be displaying one or more documents that may contain sensitive or confidential information. When a given application and associated document goes idle for a period of time, for example, where use of the document ceases for a period of time or where another application and/or associated document receives user focus for a period of time, processing of the application and associated document not in use may be suspended. Unfortunately, a display of sensitive or confidential information in the idle document may be exposed to unauthorized persons. While a document may be automatically locked from display at the instant the document application goes idle, a user will have to unlock the document after every brief idle period, which may cause fatigue and annoyance. In addition, if the document is locked when processing of the suspended application is resumed, the contents of the document may be seen and potentially copied before the document is locked.

It is with respect to these and other considerations that the present invention has been made.

### SUMMARY

This summary is provided to introduce a selection of concepts in a simplified form that are further described below in the detailed description. This summary is not intended to identify key features or essential features of the claimed subject matter, nor is it intended as an aid in determining the scope of the claimed subject matter.

Embodiments of the present invention solve the above and other problems by providing security for displayed information from unauthorized access during periods in which the displayed information may be accessed before being locked from view. When an application is running on a computing device that suspends processing of idle applications for performance enhancement, a sensitive or confidential document may be displayed by the application when the device operating system suspends processing. When processing resumes, the sensitive or confidential document may be briefly exposed to view before the application can apply security measures to protect the document from unauthorized access.

According to embodiments of the invention, when a computing device operating system notifies an application that the application will be suspended due to idle operation, the application may automatically overlay a document or other content displayed in an application user interface with a security cover to prevent unauthorized review or screen capture of the document or other content. If re-focus on the application and/or associated document occurs prior to the expiration of the period during which the displayed information may be accessed, the security overlay may be automatically removed to allow immediate access by the user. However, if re-focus on the application and/or associated document occurs after the expiration of this period, then the application document or other content may be encrypted and password entry may be required to gain subsequent access to the document.

The details of one or more embodiments are set forth in the accompanying drawings and description below. Other features and advantages will be apparent from a reading of the following detailed description and a review of the associated drawings. It is to be understood that the following detailed description is explanatory only and is not restrictive of the invention as claimed.

### BRIEF DESCRIPTION OF THE DRAWINGS

The accompanying drawings, which are incorporated in and constitute a part of this disclosure, illustrate various embodiments of the present invention.

FIG. 1 illustrates a system architecture for providing security for displayed application documents or other content.

FIG. 2 illustrates transition of a displayed application document from an unsecured mode to a secured mode.

FIG. 3 illustrates a document security overlay/cover for covering a document from exposure to unauthorized access.

FIG. 4 is a flowchart of a method for providing a security overlay/cover for a document or other content to prevent unauthorized access to the document or other content.

FIG. 5 is a block diagram illustrating example physical components of a computing device with which embodiments of the invention may be practiced.

FIGS. 6A and 6B are simplified block diagrams of a mobile computing device with which embodiments of the present invention may be practiced.

FIG. 7 is a simplified block diagram of a distributed computing system in which embodiments of the present invention may be practiced.

### DETAILED DESCRIPTION

As briefly described above, embodiments of the present invention are directed to securing electronic documents and other content from unauthorized access, review, screen capture or other use during periods in which application processing suspension and reactivation may allow for unauthorized document/content access.

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described may be modified by substituting, reordering, or adding stages to the disclosed methods. Accordingly, the following detailed description does not limit the invention but, instead, the proper scope of the invention is defined by the appended claims.

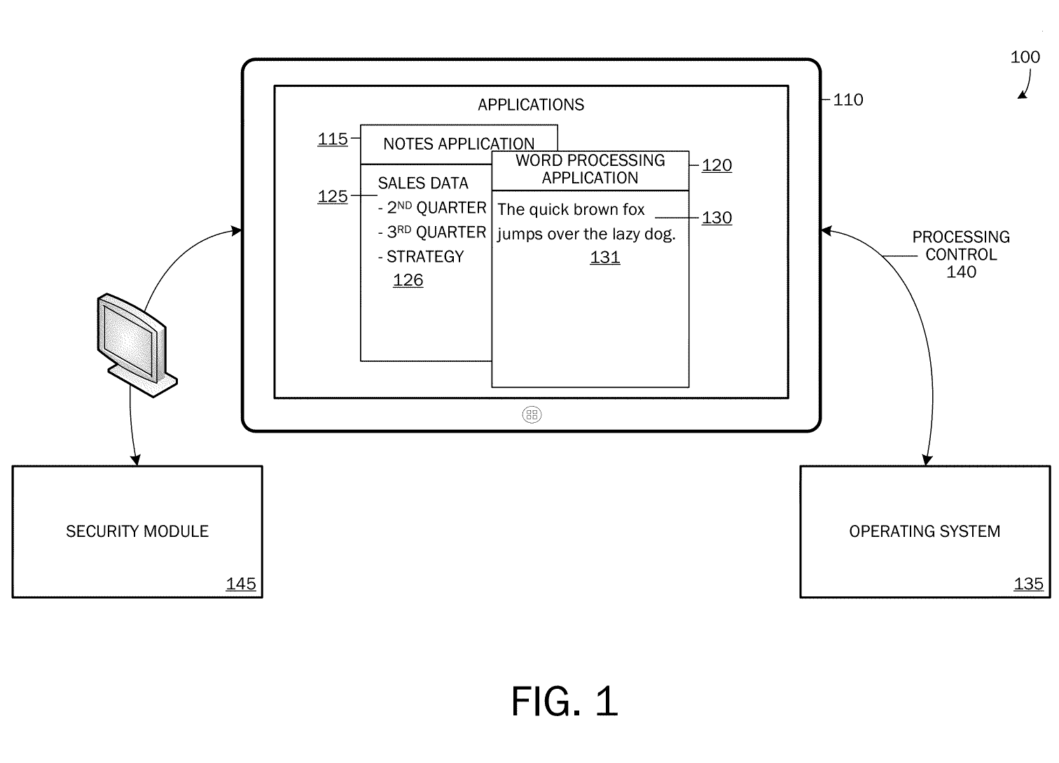

FIG. 1 illustrates a system architecture 100 for providing security for displayed application documents and other content. In FIG. 1, a computing device 110 is illustrated, and two applications 115, 120 providing user interfaces 125 and 130, respectively, are illustrated as being displayed on a display surface of the computing device 110. Documents/content 126, 131 are displayed in the illustrated user interfaces. The computing device 110 is shown as a tablet-style computing device. As should be appreciated, the computing device 110 may include any computing device operative for displaying the application user interfaces 125, 130 and documents/content 115, 120. For example, the device 110 may include a smart phone, a tablet-style computing device, a laptop computing device, a desktop computing device, and the like.

Referring to the documents/content (hereafter referred to collectively as document(s)) 126, 131, the document 126 shows an example notes application document containing one or more notes, and the document 131 shows an example word processing application document showing text content. The example word processing user interface 130 is shown partially overlaying the notes application user interface 125. According to many computing operating systems, each user interface 125, 130 may be displayed in an individual display window or pane, and each of the respective displayed user interfaces (along with associated documents) may be moved around the display surface of the computing device 110. As should be appreciated, the applications and user interfaces illustrated in FIG. 1 are for purposes example only and are not limiting of the many applications and user interfaces and associated documents or other content that may be displayed on the display surface of the computing device 110.

When a given user interface is moved into a position overlaying or partially overlaying another user interface, the user interface in a primary or surface position is the “in-focus” user interface, and the user interface being covered is the “out-of-focus” user interface. According to embodiments, an “out-of-focus” user interface, as well as, a user interface that is not being interacted with may be an indication that the associated application is idle and that processing for the application may be suspended for performance enhancement. For example, a given user may be utilizing a single software application, but the user may cease use of the application for an extended period of time while the user engages in another activity, for example, a meeting, a telephone call, and the like, and the period of non-use of the software application may indicate the application is idle, and that processing may be suspended. Similarly, a user may launch a second software application for operation on a document enabled by the second software application, but the user may not move the second software application functionality and associated document in a position overlaying a first application user interface and associated document. In such a case, the user's interaction with the second software application may indicate to the operating system 135 that the first software application and associated document are idle, and thus, the operating system may suspend processing associated with the first software application for saving processing resources.

The operating system 135, illustrated in FIG. 1, is illustrative of a computing device operating system that contains sufficient computer executable instructions for controlling operations of the computing device 110 including processing operations associated with one or more applications 115, 120 residing and functioning on or in association with the computing device 110. For example, the notes application 115 and the example word processing application 120 may be processed, including suspension of processing, at the direction of the operating system 135. That is, processing control instructions 140 may be passed from the operating system 135 to the various applications residing on or operating in association with the computing device 110 for directing when applications begin processing, cease processing, as well as, how those applications display content and interact with peripheral devices.

When a given application 115, 120 becomes idle, as described above, the operating system 135 may notify the application that its processing will be suspended to reduce needless use of processing services for the application while it is in an idle state. According to one embodiment, the operating system 135 may notify the application to be suspended that processing for that application will be suspended after the elapse of a given threshold duration/amount or period of time, for example, five seconds, which the operating system 135 may track by setting a timer (henceforth “the application suspension timer”). Once the notification is passed to the application to be suspended by the operating system 135, a separate timer (henceforth “the document re-lock timer”) may be used by the application to measure the elapse of time to determine when a document in use with the application should be encrypted and locked for security of the document. At the elapse of the application suspension timer, the operating system 135 may suspend processing for the subject application. According to embodiments, if a re-focus or other focus event (which would lead to the application being resumed) is not received for the application and/or document before the elapse of the document re-lock timer, then the document may be encrypted and locked upon re-focus of the application and/or document.

According to embodiments, processing of the suspended application may be resumed for a variety of reasons. For example, if a focus action occurs for a suspended application, then processing for the suspended application may be resumed. For example, if a user begins interaction with a suspended application user interface and/or a document displayed therein, for example, by touching the user interface, clicking on the user interface, gesturing to the user interface, issuing a voice command to the user interface, or the like, a focus action or focus event may be registered for the suspended application. As should be appreciated, when processing for a previously suspended application is resumed, processing of another application may be suspended for saving processing resources associated with the other application. For example, as illustrated in FIG. 1, if the example notes application is suspended in favor of processing of the example word processing application, upon re-focus on the suspended notes application, then processing of the example word processing application may be suspended by the operating system 135 to save processing resources accordingly.

Referring still to FIG. 1, a security module 145 is illustrated for providing security for a document enabled by a suspended software application to prevent unauthorized access to the document during the period associated with suspension and/or resumption of processing associated with the application responsible for the document. According to embodiments, the security module 145 contains sufficient computer executable instructions for providing a security overlay or cover over an application user interface or document contained therein for which unauthorized access is to be prevented during processing suspension and/or resumption activities. According to embodiments, the security module 145 may operate as part of a given application, for example, the notes application 115 or the word processing application 120, as part of the operating system 135, or the security module 145 may operate as an independent application on the computing device 110 or at a remote location accessible by the applications 115, 120. In addition, the security module 145 may operate as part of one or more other application systems, such as a software development kit (SDK).

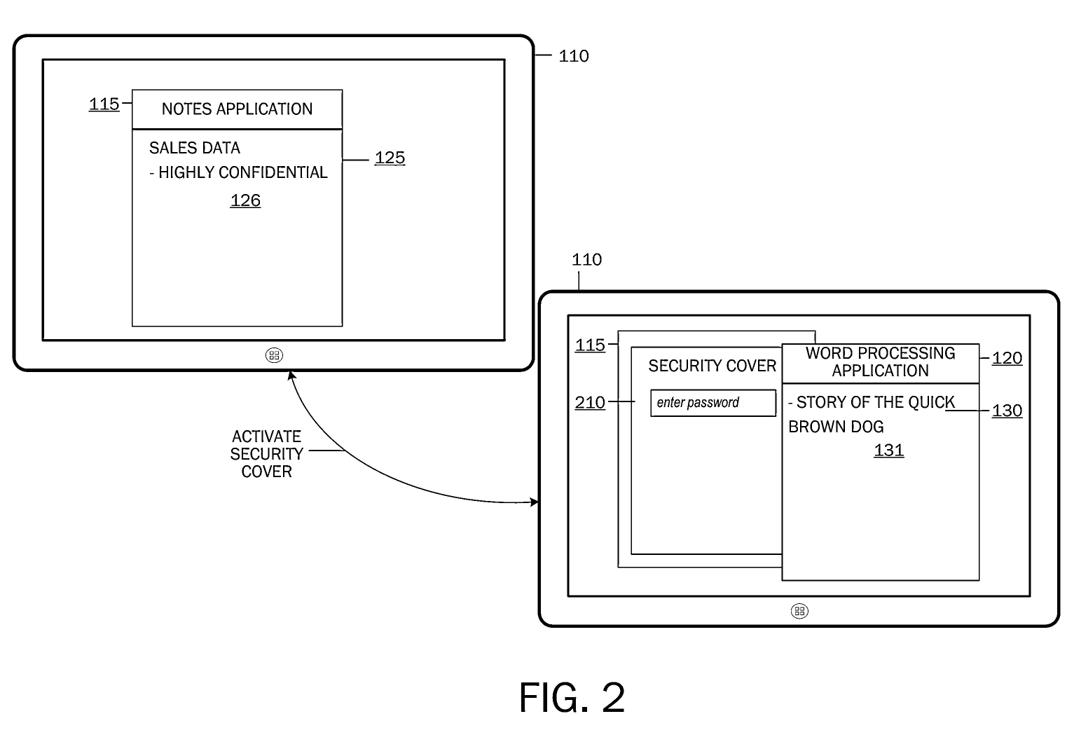

FIG. 2 illustrates transition of a displayed application document from an unsecured mode to a secured mode. On the left side of FIG. 2, a first instance of the computing device 110 is illustrated showing a notes application user interface 125 containing a document 126. Consider for example that the notes application document 126 contains a user's notes regarding a variety of topics, and consider that some of the notes being entered and/or edited by the user may contain sensitive or confidential information that should not be exposed to an unauthorized user, even for a very brief period of time. Referring to the right side of FIG. 2, a second instance of the computing device 110 is illustrated showing an example word processing application 120 that has been launched by the user for editing a document 131. For example, the user may have launched a word processing application and document for obtaining information to apply to the notes document being operated by the notes application. That is, the user may traverse back and forth between a document enabled by the word processing application and a notes document enabled by the notes application to allow the user to take notes on the content contained in the word processing application, or alternatively, to allow the user to enter information into the word processing application document from the user's notes enabled by the notes application. Thus, the focus between the two example applications and associated documents may shift quickly such that focus on one application document may last for a few seconds or more before shifting to focus on the second document which may last for a few seconds or more.

Referring to the right side of FIG. 2, according to embodiments, when the operating system 135 notifies a given application, for example, the example notes application 115 that processing for it will be suspended, a security overlay or cover 210 may be placed over the application user interface or over a document contained therein to prevent unauthorized access, including, reading, screen capture, and the like, of the content contained in the document. As described further below, if use of the application to be suspended, for example, as indicated by a re-focus on the application user interface and/or associated document occurs before the elapse of the document re-lock timer, then the security cover 210 may be immediately removed to allow the user to see the contents of the document without requiring the user to interact with the security cover for removing the security cover. According to embodiments, the determination of whether to remove the cover or to keep the cover in place and lock the document from use is made by comparing an elapsed time against the time at which the document was to be re-locked, or by checking a timer set to expire at the time at which the document was to be re-locked. Thus, if at the time of a re-focus or other focus event, all of the predetermined time has not elapsed, then the cover will be removed and the document will not be locked from use.

Accordingly, if the user is traversing from one application document to another, the security cover 210 may be placed over content contained in a document, but the security cover may be immediately removed from the document if a re-focus or focus event occurs on the application to be suspended before the predetermined time before re-locking has elapsed. Alternatively, as described further below, if the predetermined time has elapsed since the suspension notification was received, then, then the security cover 210 will be continued in place over the suspended document and the document may be encrypted and locked from use until the user actively removes the security cover, as described below.

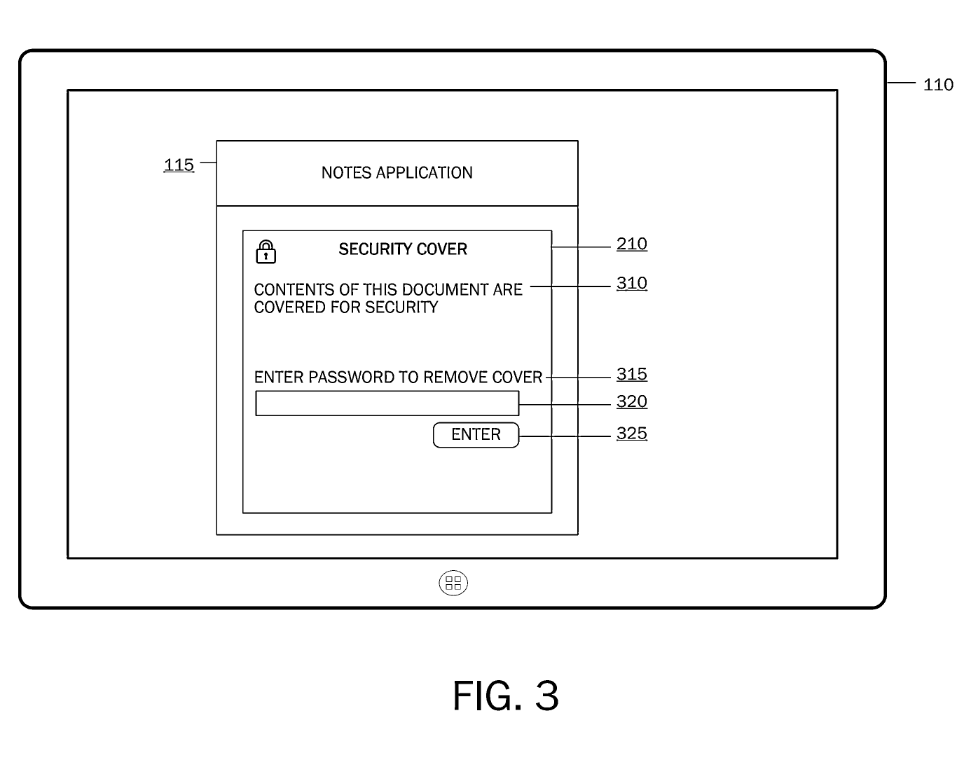

FIG. 3 illustrates a document security overlay or cover for covering a user interface or document from exposure to unauthorized access. The security cover 210 that is placed over a user interface or document enabled by a suspended software application may include an overlay or cover placed over the user interface or document to be secured that prevents an unauthorized person from reading, screen capturing, or otherwise accessing content contained in the secured user interface or document. As should be appreciated, the security cover 210 may be placed over all content of a given document, or the security cover 210 may be placed over only portions of a document that may have been designated for receiving security cover. For example, the security module 145, described above with reference to FIG. 1, may provide for a variety of security settings to be applied to use of the security cover 210 for allowing the security cover 210 to be used in association with all content of a given document or portions of content of a given document.

The security cover 210 may include information to notify the user of the nature of the security cover and for allowing the user to interact with the security cover 210. For example, a warning statement 310 may be provided for notifying the user that contents of this document are covered for security purposes. A password instruction 315 may be provided for notifying a user that a password must be entered for removing the security cover to allow access to the secured document. A password entry field 320 may be provided for entry of password alphanumeric characters or other authorization information. A password entry button or function 325 may be provided for allowing the user to submit an entered password for removing the security cover 210. As should be appreciated, information entered into the password field 320 may be submitted to a security module 145 or any other password system operated by the suspended application or by the operating system 135 operative to allow removal of the security cover 210.

As described above, if a focus event occurs on/for an application to be suspended before elapse of the predetermined time allotted to the application before re-locking of the application and/or document, the security cover 210 may be immediately removed to allow immediate access to the content secured by the security cover 210. Alternatively, if a focus event occurs on/for the subject application 115 after the elapse of the document re-lock timer, then the user may be required to enter a password or other appropriate authorization information for removal of the security cover 210 and for unlocking the document for use.

Having described an exemplary architecture for embodiments of the present invention, and having described illustrations of aspects of embodiments of the present invention above with respect to FIGS. 1 through 3, FIG. 4 is a flowchart of a method for providing a security cover or overlay for a document to prevent unauthorized review or screen capture of the document. The method 400 begins a start operation 405 and proceeds to operation 410 where an application document is being used by a user that may or may not contain sensitive or confidential information, but for which a security cover may be provided to prevent unauthorized access to the document during application suspension and/or resumption operations, as described above.

At operation 415, use of the application document goes idle for one of a number of reasons. For example, a second application and/or associated document may be moved into a position on a display surface of a computing device 110 covering part or all of the first document in use, causing the operating system 135 to shift processing functionality to the secondary application and/or document. Or, the first document in use by the user may go idle because the user simply stops interacting with the document while the user performs some other activity, for example, taking a telephone call, engaging in a meeting or other conversation, or the like.

At operation 420, the application associated with the idle document or associated user interface receives a notification from the operating system 135 that, owing to its idle state or various other conditions, processing services for the application will be suspended after the elapse of a set duration/amount of time, for example, five seconds. At operation 425, upon receipt of the processing suspension notification, the application to be suspended in association with the security module 145 automatically covers the associated user interface and/or document in use with a security cover 210, as illustrated in FIGS. 2 and 3.

At operation 430, upon placement of the security cover over the idle user interface or document, the application to be suspended in association with the security module 145 starts a timer for recording elapsed time from receipt of the suspension notification and placement of the security cover over the document for determining whether or not the predetermined time before the document will be locked from use is met prior to receipt of a next focus event. According to embodiments, the elapsed time may be obtained through a variety of suitable means, for example, the system clock operated by the operating system 135 accessible by the application to be suspended, or by a counter operated by the application 115 to be suspended, or alternatively by a counter operated by the security module 145.

At operation 435, a focus event or re-focus is received on the user interface or document associated with the application notified for suspension. For example, a touch, gesture, mouse click, stylus contact, voice command, or any other suitable command that may be received and understood by the application receiving the suspension notification may be received for indicating a focus event or re-focus on the user interface or document associated with the application receiving the suspension notice. As should be appreciated, at the time of the receipt of the focus event, the predetermined allotted time before document lock may or may not have elapsed. For example, the suspension notice may have been received one minute before the document was scheduled to be locked, but the associated document may have received a focus event after 30 seconds of elapsed time (in which case the security cover may be removed with no additional user input required). Alternatively, at the time of the focus event on the document, more than one minute may have elapsed meaning that the document will have been locked from use.

At operation 440, the security module 145 compares the elapsed time since the receipt of the suspension notification with the predetermined time allowed before the document is locked and application processing is suspended, and at operation 445, a determination is made as to whether the document should be locked from use. If the predetermined time has not elapsed, the document should not be locked from use, meaning that a focus event has occurred on the user interface or document prior to locking the document. The method 400 then proceeds to operation 460, and the security cover 210 is automatically removed to allow the user immediate access to the user interface and/or contents of the document without further delay or input by the user.

Alternatively, if at operation 445, if the document re-lock time has been reached, meaning that the time between the suspension notification and the time of the focus event on the user interface or document exceeds the amount of time during which the document was permitted to be viewed by the user, then the method proceeds to operation 450. At operation 450, the document is encrypted to secure the document from access, revision, or use in any manner including application of functionality to the document. At operation 455, the security cover 210 continues to be displayed in position over the user interface and/or document. In order to remove the cover 210, the user must enter a password or provide other authorization or authentication information or credentials for removing the security cover 210. If the password, other authorization or authentication information or other credentials provided by the user is accepted by the security module 145, or other module or component responsible for reviewing and accepting received credentials, then the method proceeds to operation 460. At operation 460, the security cover 210 is removed from the user interface and/or document to allow the user access and utilization of the document, as desired, in association with the functionality of the previously suspended application. The method ends at operation 495.

While the invention has been described in the general context of program modules that execute in conjunction with an application program that runs on an operating system on a computer, those skilled in the art will recognize that the invention may also be implemented in combination with other program modules. Generally, program modules include routines, programs, components, data structures, and other types of structures that perform particular tasks or implement particular abstract data types.

The embodiments and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the embodiments and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

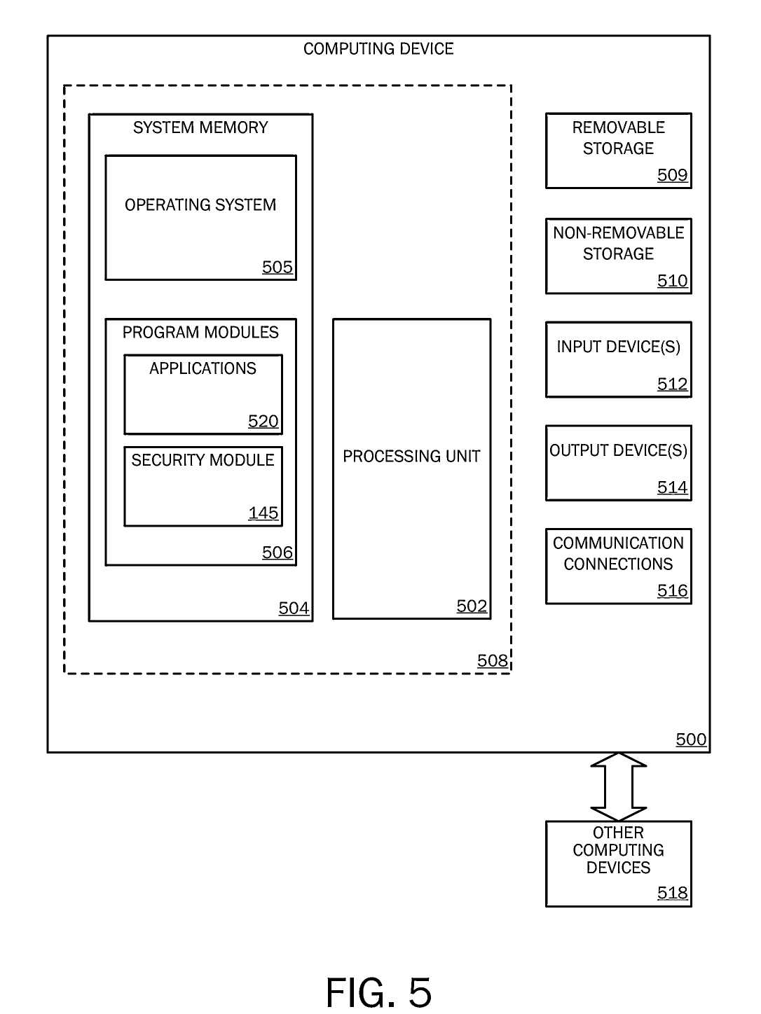

FIGS. 5-7 and the associated descriptions provide a discussion of a variety of operating environments in which embodiments of the invention may be practiced. However, the devices and systems illustrated and discussed with respect to FIGS. 5-7 are for purposes of example and illustration and are not limiting of a vast number of computing device configurations that may be utilized for practicing embodiments of the invention, described herein.

FIG. 5 is a block diagram illustrating physical components (i.e., hardware) of a computing device 500 with which embodiments of the invention may be practiced. The computing device components described below may be suitable for the computing device 110 described above. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories. The system memory 504 may include an operating system 505 and one or more program modules 506 suitable for running software applications 520 such as the applications 115, 120 and module 145, described above. The operating system 505, for example, may be suitable for controlling the operation of the computing device 500. Furthermore, embodiments of the invention may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

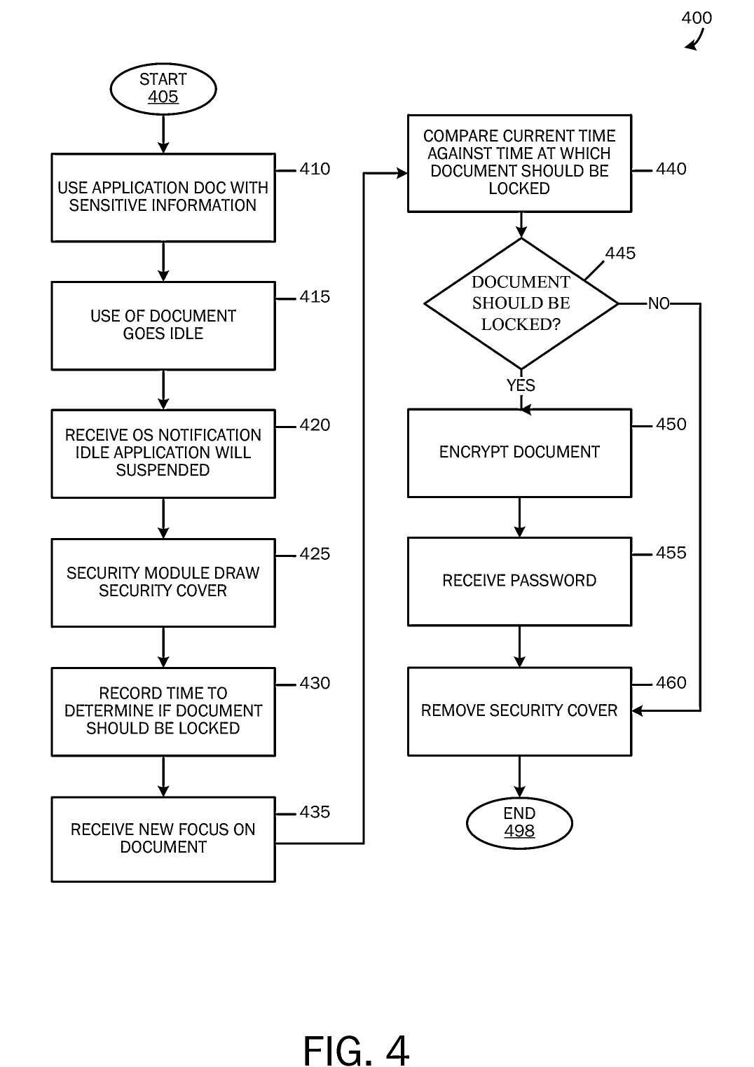

As stated above, a number of program modules and data files may be stored in the system memory 504. While executing on the processing unit 502, the program modules 506 (e.g., the security module 145) may perform processes including, but not limited to, one or more of the stages of the method 400 illustrated in FIG. 4. Other program modules that may be used in accordance with embodiments of the present invention may include applications 115, 120 such as, notes applications, electronic mail and contacts applications, word processing applications, spreadsheet applications, database applications, slide presentation applications, drawing or computer-aided application programs, etc.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the security module 145 may be operated via application-specific logic integrated with other components of the computing device 500 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

The computing device 500 may also have one or more input device(s) 512 such as a keyboard, a mouse, a pen, a sound input device, a touch input device, etc. The output device(s) 514 such as a display, speakers, a printer, etc. may also be included. The aforementioned devices are examples and others may be used. The computing device 500 may include one or more communication connections 516 allowing communications with other computing devices 518. Examples of suitable communication connections 516 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500.

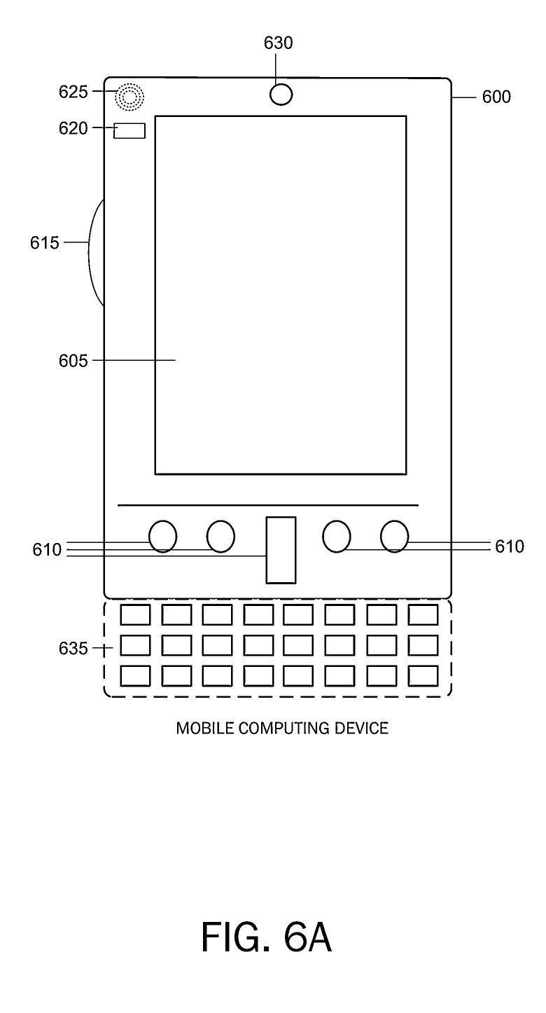

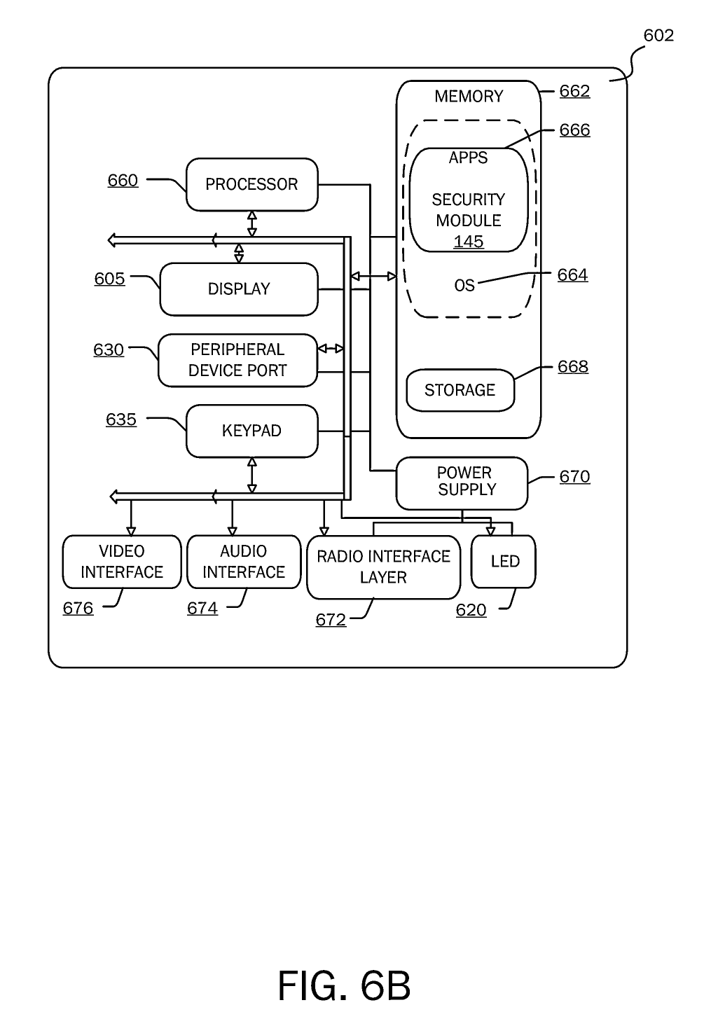

FIGS. 6A and 6B illustrate a mobile computing device 600, for example, a mobile telephone, a smart phone, a tablet-style personal computer 110, a laptop computer, and the like, with which embodiments of the invention may be practiced. With reference to FIG. 6A, one embodiment of a mobile computing device 600 for implementing the embodiments is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative embodiments, mobile computing device 600 may incorporate more or less input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some embodiments, the mobile computing device 600 incorporates a vibration transducer for providing the user with tactile feedback. In yet another embodiment, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one embodiment of a mobile computing device. That is, the mobile computing device 600 can incorporate a system (i.e., an architecture) 602 to implement some embodiments. In one embodiment, the system 602 is implemented as a “smart phone” capable of running one or more applications (e.g., browser, e-mail, calendaring, contact managers, messaging clients, games, and media clients/players). In some embodiments, the system 602 is integrated as a computing device, such as an integrated personal digital assistant (PDA) and wireless phone.

One or more application programs may be loaded into the memory 662 and run on or in association with the operating system 664. Examples of the application programs include phone dialer applications, e-mail applications, personal information management (PIM) applications, word processing applications, spreadsheet applications, Internet browser applications, notes applications, messaging applications, and so forth. The system 602 also includes a non-volatile storage area 668 within the memory 662. The non-volatile storage area 668 may be used to store persistent information that should not be lost if the system 602 is powered down. The application programs may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600, including the security module 145 described herein.

The system 602 has a power supply 670, which may be implemented as one or more batteries. The power supply 670 might further include an external power source, such as an AC adapter or a powered docking cradle that supplements or recharges the batteries.

The system 602 may also include a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 120 via the operating system 664, and vice versa.

The visual indicator 620 may be used to provide visual notifications and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present invention, the microphone may also serve as an audio sensor to facilitate control of notifications, as will be described below. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

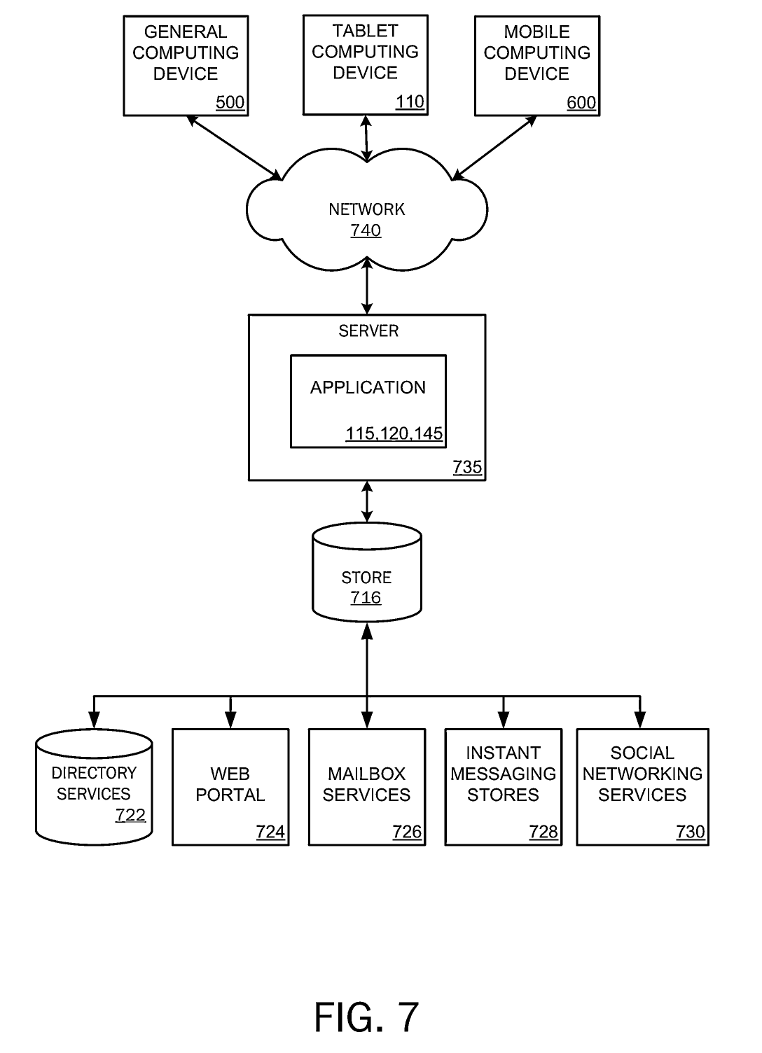

FIG. 7 illustrates one embodiment of the architecture of a system for providing document security, as described above. Content developed, interacted with, or edited in association with the security module 145 may be stored in different communication channels or other storage types. For example, various documents and stored content items may be stored using a directory service 722, a web portal 724, a mailbox service 726, an instant messaging store 728, or a social networking site 730. The security module 145 may use any of these types of systems or the like for enabling data utilization, as described herein. A server 735 may provide output of the security module 145 to clients. As one example, the server 735 may be a web server providing the document security over the web. The server 735 may provide the output of the security module 145 over the web to clients through a network 740. By way of example, the client computing device may be implemented and embodied in a personal computer 500, a tablet computing device 110 and/or a mobile computing device 600 (e.g., a smart phone), or other computing device. Any of these embodiments of the client computing device 500, 110, 600 may obtain content from the store 716.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

We claim:

1. A computer implemented method of securing a document from access;
comprising:
displaying an electronic document in a computer-enabled user interface;
receiving a notification that processing of an application displaying the document will be suspended;
in response to receiving the notification, covering the electronic document from view;
receiving a focus action on the electronic document; and
after receiving the focus action, if a predeterimined duration of time has not elapsed between receiving the notification and receiving the focus action, discontinuing covering the electronic document from view.

2. The method of claim 1, wherein after receiving the focus action, if the predeterimined duration of time has elapsed between receiving the notification and receiving the focus action, continuing covering the electronic document from view and locking the electronic document from use.

3. The method of claim 2, further comprising:
receiving a request to discontinue covering the electronic document from view; and
if the request to discontinue covering the electronic document is approved, discontinuing covering the electronic document from view and unlocking the document from use.

4. The method of claim 3, wherein receiving a request to discontinue covering the electronic document from view includes receiving a document access authorization from a requesting user.

5. The method of claim 4, wherein receiving a document access authorization from a requesting user includes receiving a password from the requesting user.

6. The method of claim 1, wherein receiving a notification that operation of an application displaying the document will be suspended includes receiving a notification that the application displaying the document will be suspended after a predetermined duration of time and that the electronic document will be locked from use.

7. The method of claim 6, wherein after receiving a focus action on the electronic document, determining whether the predetermined duration of time has elapsed since receiving the notification, wherein if the predetermined duration of time has not elapsed, determining that the electronic document is not locked from use.

8. The method of claim 6, wherein after receiving a focus action on the electronic document, determining whether the predetermined duration of time has elapsed since receiving the notification, wherein if the predetermined duration of time has elapsed, determining that the electronic document is locked from use.

9. The method of claim 1, wherein covering the electronic document from view includes covering the computer-enabled user interface such that the electronic document cannot be viewed in the computer-enabled user interface.

10. The method of claim 1, wherein receiving a notification that processing of an application displaying the document will be suspended includes receiving the notification from an operating system directed to the application displaying the document.

11. A computer implemented method of securing a document from access;
comprising:
receiving a first notification from an operating system that processing for an idle application is about to be suspended after the elapse of a time duration;
displaying an electronic security cover over an application user interface for hiding one or more contents displayed in the application user interface from view;
receiving an indication that the application has become active;
if the time duration has not elapsed, discontinuing displaying the electronic security cover over the application user interface; and
if the time duration has elapsed, encrypting the one or more contents displayed in the application user interface, and continuing displaying the electronic security cover over the application user interface.

12. The method of claim 11, further comprising:
wherein after continuing displaying the electronic security cover over the application user interface, receiving a request to discontinue displaying the electronic security cover over the application user interface; and
if the request is approved, discontinuing displaying the electronic security cover over the application user interface.

13. The method of claim 12, wherein receiving a request to discontinue displaying the electronic security cover over the application user interface includes receiving an access authorization from a requesting user.

14. The method of claim 13, wherein receiving an access authorization from a requesting user includes receiving a password from the requesting user.

15. The method of claim 11, wherein receiving an indication that the application has become active includes receiving a focus action on the user interface for enabling user interaction with the user interface.

16. The method of claim 11, wherein receiving an indication that the application has become active includes receiving an indication that the application user interface has been moved into a top level display position relative to one or more other application user interfaces.

17. A system for securing a document from access, comprising:
one or more processors; and
a memory coupled to the one or more processors, the one or more processors operable to:
display an electronic document in a computer-enabled user interface;
receive a notification from an operating system associated with the one or more processors that operation of an application displaying the document will be suspended;
cover the electronic document from view in response to receiving the notification;
receive a focus action on the electronic document; and
discontinue covering the electronic document from view if a predetermined duration of time after receiving the notification has not elapsed when the focus action is received.

18. The system of claim 17, being further operable to continue covering the electronic document from view wherein if the predetermined duration of time after receiving the notification has elapsed when the focus action is received.

19. The system of claim 18, being further operable to:
receive a request to discontinue covering the electronic document from view; and
discontinue covering the electronic document from view if the request to discontinue covering the electronic document is approved.

20. The system of claim 19, wherein a request to discontinue covering the electronic document from view includes a document access authorization request from a requesting user.
